(19) United States
(12) Patent Application Publication
(10) Pub. No.: US 2025/0028776 A1
(43) Pub. Date: Jan. 23, 2025

(54) PAGE PROCESSING METHOD AND DEVICE

(71) Applicant: BEIJING BYTEDANCE NETWORK TECHNOLOGY CO., LTD., Beijing (CN)

(72) Inventor: Xinhao LI, Beijing (CN)

(21) Appl. No.: 18/714,072

(22) PCT Filed: Nov. 2, 2022
(86) PCT No.: PCT/CN2022/129227

§ 371 Date: May 28, 2024

(30) Foreign Application Priority Data
Nov. 29, 2021 (CN) 202111431763.8

(51) Int. Cl. G06F 16/958; G06F 3/0483

(52) U.S. Cl. CPC G06F 16/958; G06F 3/0483

(57) ABSTRACT

Embodiments of the present disclosure provide a page processing method and device, an electronic device, a storage medium, a computer program product, and a computer program. The method includes: receiving a page display request; loading a page resource of a target page in response to the page display request, where the page resource includes a configuration file and page logic from a server, and the target page is a native page; and displaying the target page based on the page resource.

### CROSS-REFERENCE TO RELATED APPLICATIONS

The present disclosure is a U.S. National Stage under 35 U.S.C. § 371 of International Application No. PCT/CN2022/129227, filed on Nov. 2, 2022, which is based on and claims priority to Chinese Patent Application No. 202111431763.8, filed with the China National Intellectual Property Administration on Nov. 29, 2021, and entitled “PAGE PROCESSING METHOD AND DEVICE”, which are incorporated herein by reference in their entireties.

### TECHNICAL FIELD

Embodiments of the present disclosure relate to the field of computer technologies, and in particular, to a page processing method and device, an electronic device, a storage medium, a computer program product, and a computer program.

### BACKGROUND ART

With the development of front-end technologies, a variety of client native pages have been designed for applications. For the sake of simplicity, the client native page is hereinafter referred to as a native page for short.

A page framework of the native page is stored in a client and is related to the version of an application downloaded by a user. Currently, page logic of the native page is bound to the page framework of the native page, which requires the user to manually upgrade the application in an application store to update the page logic of the native page. The page logic is processing logic related to the overall page, for example, reporting corresponding information after the page is loaded.

It can be seen that it is currently impossible to update the page logic in a timely manner.

### SUMMARY OF THE INVENTION

According to a first aspect, an embodiment of the present disclosure provides a page processing method. The method includes:
receiving a page display request;
loading a page resource of a target page in response to the page display request, where the page resource includes page logic from a server, and the target page is a native page; and displaying the target page based on the page resource.

In a second aspect, an embodiment of the present disclosure provides a page processing device. The page processing device includes:
a receiving unit configured to receive a page display request;
a loading unit configured to load a page resource of a target page in response to the page display request, where the page resource includes page logic from a server, and the target page is a native page; and
a display unit configured to display the target page based on the page resource.

In a third aspect, an embodiment of the present disclosure provides an electronic device. The electronic device includes: at least one processor and a memory,
where the memory stores computer-executable instructions; and
the at least one processor executes the computer-executable instructions stored in the memory, to cause the at least one processor to perform the page processing method as described in the first aspect or various possible designs of the first aspect.

In a fourth aspect, an embodiment of the present disclosure provides a non-transitory computer-readable storage medium storing computer-executable instructions that, when executed by a processor, cause the page processing method as described in the first aspect to be implemented.

In a fifth aspect, an embodiment of the present disclosure provides a computer program product including computer-executable instructions that, when executed by a processor, cause the page processing method as described in the first aspect to be implemented.

According to a sixth aspect, an embodiment of the present disclosure provides a computer program that, when executed by a processor, causes the page processing method as described in the first aspect to be implemented.

### BRIEF DESCRIPTION OF DRAWINGS

In order to more clearly describe the technical solutions in the embodiments of the present disclosure or in the prior art, the drawings for describing the embodiments or the prior art will be briefly described below. Apparently, the drawings in the description below show some embodiments of the present disclosure, and persons of ordinary skill in the art may still derive other drawings from these drawings without creative efforts.

FIG. 1 is an example diagram of a page including a plurality of cards;

FIG. 2 is a schematic diagram of an application scenario to which an embodiment of the present disclosure is applicable;

FIG. 3 is a first schematic flowchart of a page processing method according to an embodiment of the present disclosure;

FIG. 4 is a second schematic flowchart of a page processing method according to an embodiment of the present disclosure;

FIG. 5 is a block diagram of a structure of a page processing device according to an embodiment of the present disclosure; and

FIG. 6 is a schematic diagram of a hardware structure of an electronic device according to an embodiment of the present disclosure.

### DETAILED DESCRIPTION OF THE INVENTION

In order to make the purposes, technical solutions and advantages of the embodiments of the present disclosure clearer, the technical solutions in the embodiments of the present disclosure will be described clearly and completely below with reference to the accompanying drawings in the embodiments of the present disclosure. Apparently, the described embodiments are some, rather than all, of the embodiments of the present disclosure. All other embodiments obtained by those of ordinary skill in the art based on the embodiments of the present disclosure without creative efforts shall fall within the scope of protection of the present disclosure.

Embodiments of the present disclosure provide a page processing method and device, an electronic device, a storage medium, a computer program product, and a computer program, to solve the problem of it being impossible to update page logic in a timely manner.

According to the page processing method and device, the electronic device, the storage medium, the computer program product, and the computer program provided in the embodiments of the present disclosure, the page resource of the target page is loaded in response to the page display request, where the page resource includes the page logic from the server, and the target page is the native page; and the target page is displayed based on the page resource. Therefore, during a page display process, the server dynamically delivers the page logic, so that the page logic can be updated in a timely manner and it is ensured that the page logic can run in a timely manner, to ensure the normal display of the page, thereby improving the user experience.

First, a brief explanation of the terms involved in the present disclosure is given.

Client native page (hereinafter referred to as native page): Unlike a web page, page code of the native page (especially implementation code of the page framework) is stored in a client, and the version of the page code is related to the version of an application downloaded by a user. Therefore, there is no need to visit a remote link to obtain page code every time a page is opened. If the user wants to update the native page, the user needs to manually upgrade the application to which the native page belongs on the client.

Card: The card is a segment of code that is executed independently and can be dynamically delivered. In addition to logic layer data, the card may also include view layer data such as pictures and fonts, which can be displayed as cards visible to users on the page.

Business logic: The business logic is logic related to business data processing. For example, an avatar, a nickname, sports data, etc. of the user are displayed in a designated area on the page.

Page logic: The page logic is logic related to processing of the overall page. For example, whether to display a pop-up window on the page, record a page-level log, or refresh the page is determined based on a page state.

In a page logic processing method, the page logic of the native page is bound to the page framework of the native page. However, in this method, users need to manually upgrade the application to update the page logic of the native page, resulting in an inability to update the page logic in a timely manner.

In another page logic processing method, the page logic of the native page is stored in a card containing the business logic. However, there are still disadvantages in this method. In some short screens, only part of the card at the top of the page may be displayed, the card at the bottom of the page is not displayed (which requires the user to manually swipe to a corresponding position so that the card at the bottom of the page is displayed), and the logic layer data in the card that is not displayed will not be loaded and run, resulting in a failure in the page logic. Moreover, business is changeable, and when a card is canceled (i.e., deleted) or the position of the card changes due to a change in business, the page logic may fail.

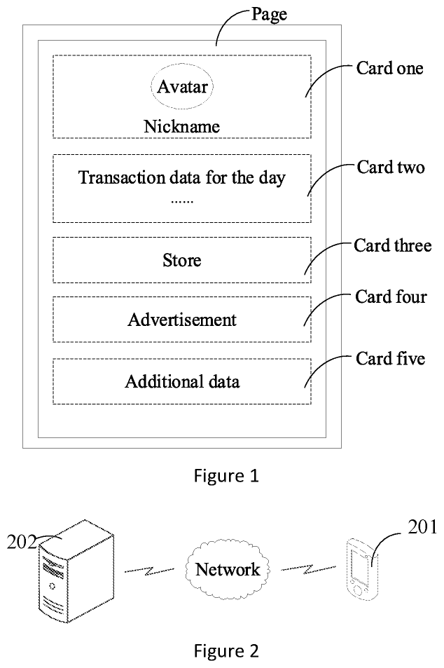

For example, refer to FIG. 1. FIG. 1 is an example diagram of a page including a plurality of cards. In FIG. 1, five cards are displayed on the page: a card one, a card two, a card three, a card four, and a card five. An avatar and a nickname of a user are displayed on the card one. Transaction data of the user for the day is displayed on the card two. A store of the user is displayed on the card three. An advertisement is displayed on the card four. Some additional data related to the user is displayed on the card five. If the page logic is placed in logic layer data of the card five, the card five may not be displayed in a short screen, causing a failure in the page logic. If the page logic is placed in logic layer data of the card one, if the card one is canceled due to a change in business, the page logic is also deleted, which requires a developer to redeploy the page logic at other positions.

In order to solve the above problems, the embodiments of the present disclosure provide a page processing method and device, an electronic device, a storage medium, a computer program product, and a computer program. In the embodiment of the present disclosure, when a page display request is received, a page resource of a page is loaded. The page resource includes page logic dynamically delivered by a server. Therefore, the page logic dynamically delivered by the server is the latest page logic of the page, which ensures a timely update of the page logic, thereby improving a page display effect. In addition, the page logic is loaded when the page display request is received, which ensures that the page logic of the page exists on the client during display of the page, thereby helping to ensure the running of the page logic and the normal display of the page.

FIG. 2 is a schematic diagram of an application scenario to which an embodiment of the present disclosure is applicable.

As shown in FIG. 2, in this application scenario, devices involved include a terminal 201 and a server 202, where the terminal 201 has an application (not shown in FIG. 2) installed thereon, and the terminal 201 communicates with the server 202 through, for example, a network. When the application on the terminal 201 is used, the user can open a page of the application on the terminal 201, for example, by opening a home page of the application by clicking the application on the screen, or switching to another page by performing a swipe-left operation or a swipe-right operation on the screen. When detecting a request of the user to open the page, the terminal 201 can obtain a page resource of the page locally and on the server 202, and then display the page.

A plurality of embodiments of the present disclosure are provided below. An execution body of the plurality of embodiments of the present disclosure may be a terminal. The terminal may be a personal digital assistant (PDA) device, a handheld device (such as a smartphone or a tablet computer), a computing device (such as a personal computer (PC)), a vehicle-mounted device, a wearable device (such as a smartwatch or a smart band), a smart household device (such as a smart display device), etc.

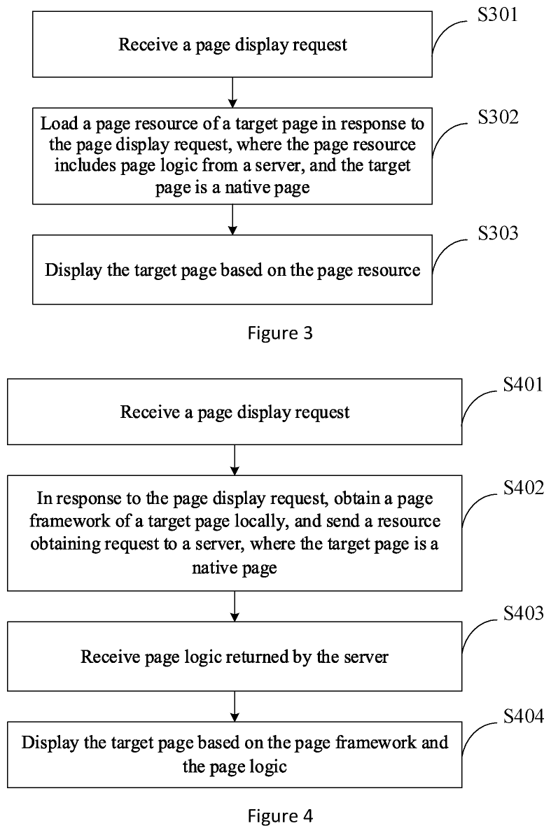

FIG. 3 is a first schematic flowchart of a page processing method according to an embodiment of the present disclosure. As shown in FIG. 3, the page processing method includes the following steps.

S301: Receive a page display request.

The page display request is used to request the display of a page of an application. For the sake of simplicity, in the embodiment of the present disclosure, the page to be displayed according to the page display request is referred to as a target page.

In this embodiment, a page display request triggered by a user or an application can be received.

In an example, in response to an operation of starting the application by the user, the page display request triggered by the user is received. In this case, the target page to be displayed according to the page display request is a preset page of the application, such as a home page of the application, or a page most frequently visited by the user in the application.

In another example, in response to a swiping operation of the user on the screen, the page display request triggered by the user is received. In this case, the target page to be displayed according to the page display request may be a previous or next adjacent page of a currently displayed page on the display screen.

In still another example, a page display request triggered by a page jump program in the application is received. For example, “jump to the target page in 3 seconds” is displayed on the display screen of the terminal, and the page display request triggered by the page jump program is received in 3 seconds.

S302: Load a page resource of a target page in response to the page display request, where the page resource includes page logic from a server, and the target page is a native page.

The page resource refers to resource files that assist in page display, for example, pictures, text, and other resources.

In this embodiment, part of the page resource of the target page is stored locally in the terminal, and another part of the page resource is stored in the server, where the page resource stored in the server includes the page logic of the target page. Therefore, after the page display request is received, the terminal loads the page resource of the target page locally and from the server, in particular, the terminal loads the page logic of the target page from the server, such that the server dynamically delivers the page logic of the target page during display of the target page.

Data stored on the server is data of the latest version of the application. Therefore, the terminal loads, in response to a page loading request, the page logic dynamically delivered by the server, which makes it possible to obtain the latest page logic of the target page to implement a timely update of the page logic, and also allows for timely loading of the page logic, thereby helping to ensure the running of the page logic and the normal display of the page.

S303: Display the target page based on the page resource.

In this embodiment, after the page resource is obtained, page rendering of the target page is performed on the display screen of the terminal based on the page resource, to implement the display of the target page. Performing the page rendering of the target page based on the page resource includes running the page logic during the page rendering. Here, the specific process of performing page rendering based on the page resource is not limited, and for the process, reference may be made to existing implementations.

After the target page is displayed, the page logic may also be run. For example, after it is detected that the user enters text in a search box on the target page and clicks Search, the page logic is run to send the text in the search box to the server for search. For another example, after a page is displayed abnormally, the page logic is run to promptly feed back a message about a page display abnormality to the server.

In this embodiment of the present disclosure, when the page display request is received, the page resource of the page is loaded. The page resource includes the page logic dynamically delivered by the server. Thus, the timely update and timely loading of the page logic are implemented, which helps to ensure the running of the page logic and the normal display of the page and improving the page display effect, thereby providing the user with a better experience.

FIG. 4 is a second schematic flowchart of a page processing method according to an embodiment of the present disclosure. As shown in FIG. 4, the page processing method includes the following steps.

S401: Receive a page display request.

For the implementation principles and technical effects of S401, reference may be made to the foregoing embodiments, which will not be described again.

S402: In response to the page display request, obtain a page framework of a target page locally, and send a resource obtaining request to a server, where the target page is a native page.

In this embodiment, after the page display request is received, the terminal loads a page resource of the target page in response to the page display request. Considering that the target page is the native page and a page framework of the native page is usually stored locally in the terminal, the terminal loading the page resource of the target page includes the terminal loading the page framework of the target page locally. Therefore, in response to the page display request, the terminal obtains the page framework of the target page locally and sends the resource obtaining request to the server, so as to request the loading of the page resource of the target page that is located on the server.

S403: Receive page logic returned by the server.

In this embodiment, after receiving the resource obtaining request, the server can obtain the page resource of the target page from page resources of a plurality of pages based on an application identifier (for example, an application name) carried in the resource obtaining request and a page identifier of the target page, where the page resource of the target page stored on the server side includes page logic of the target page. Afterwards, the server returns the page logic of the target page to the terminal, and the terminal receives the page logic returned by the server. Thus, the page logic is dynamically delivered during the page display, the page logic is updated in a timely manner, and the page display effect is improved.

S404: Display the target page based on the page framework and the page logic.

In this embodiment, the page framework and the page logic are run to perform page rendering of the target page, so as to implement page display of the target page.

In addition to the page framework of the target page, the page resource of the target page may also include picture resources, text resources, video resources, etc. The terminal can load these resources locally or from the server, and combine these resources, the page framework, and the page logic to perform page rendering of the target page.

In the embodiment of the present disclosure, the page framework of the target page is obtained locally in response to the page display request, and the page logic of the target page is obtained from the server, such that the advantage of a high page display efficiency of the native page is retained, and the timely update and timely loading of the page logic are implemented, thus improving the page display effect and providing the user with a better experience.

In some embodiments, based on any of the foregoing embodiments, the page resource of the target page includes a card resource of a target card, and the card resource of the target card includes only the page logic. In this case, when loading the page resource of the target page, the terminal can request the server to load the card resource of the target card to obtain the card resource of the target card that is returned by the server, thereby obtaining the page logic of the target page.

It can be seen that in this method, the dynamic delivery of the page logic is implemented by utilizing the characteristics of the card being independently executable and dynamically delivered code. Moreover, the target card includes only the page logic and thus does not change due to a change in business, thereby avoiding a failure in the page logic due to the change in business.

In some embodiments, the page resource also includes a configuration file from the server, where the configuration file includes configuration parameters related to display of the target page, such as a page background color and a page size. In this case, the terminal loading the page resource of the target page in response to the page display request includes: loading the configuration file and page logic from the server.

In some embodiments, when the page resource also includes the configuration file from the server, the page resource of the target page includes the card resource of the target card, and the card resource of the target card includes only the page logic, a display position, a display order, and/or a display mode of the target card can be preset in the configuration file, to ensure that the target card is displayed when the terminal displays the target page in response to the page display request, without being limited by the length of the display screen. As for how to set the display position, the display order, and the display mode of the target card in the configuration file to achieve this effect, there are various implementations as follows.

In a possible implementation, in the configuration file of the target card, the display position of the target card is at the top of the page of the target card. In this case, the displaying the target page based on the page resource includes: displaying the target card at the top of the target page.

In this implementation, considering that the length of the display screen affects the display of the card located in the lower half of the page, instead of the display at the top of the page, in other words, the display of the part at the top of a page will definitely be implemented when the page is displayed regardless of the length of the display screen, the display position of the target card can be preset, in a target configuration file, to be at the top of the page of the target card. In this way, when the target page is displayed, the target card is displayed at the top of the target page. Therefore, when the page is displayed, the card that includes only the page logic will definitely be displayed (this can ensure that the page logic of the card is loaded when the page is displayed), and even when the page also includes other cards, the card that includes only the page logic will not be affected by other cards. For example, when other cards are canceled due to a change in business, the display position of the card that includes only the page logic does not change.

In another possible implementation, the target page includes a plurality of cards, the configuration file of the target card includes the display order of the plurality of cards, and the target card is the first card in the plurality of cards in the display order. In this case, the displaying the target page based on the page resource includes: displaying the plurality of cards on the target page according to the display order of the plurality of cards.

In this implementation, when the target page includes the plurality of cards, considering that the length of the display screen has more impact on the cards located at lower positions, and has less impact on the display of the first card, the target card can be preset, in the configuration file, to be displayed first. In this way, when the plurality of cards on the target page are displayed according to the display order of the plurality of cards, the target card is displayed as the first card on the target page. Therefore, it is ensured that the card resource of the card that includes only the page logic can be loaded when the page is displayed, and the display of the card is not affected by other cards.

In another possible implementation, in a configuration file of the target page, the display position of the target card is a fixed position on the display screen. In this case, displaying the target page based on the page resource includes: displaying the target card at the fixed position on the display screen where the target page is located.

For example, the display screen can be regarded as a two-dimensional coordinate system, and the display position of the target card in the configuration file of the target page is at two-dimensional coordinates in the two-dimensional coordinate system or in a local area in the two-dimensional coordinates. For example, the display position of the target card can be preset, in the configuration file of the target page, as a position or area at the top, in the middle, or at the bottom of the display screen.

In this implementation, the display position of the target card is set to the fixed position on the display screen, such that regardless of the length of the display screen, that is, regardless of whether the entire content of the target page is displayed on the display screen, the target card can be displayed at the fixed position, thus ensuring the display of the target card. Therefore, it is ensured that the card resource of the card that includes only the page logic can be loaded when the page is displayed.

In yet another possible implementation, in the configuration file of the target page, the display mode of the target card is a floating layer mode. In this case, the displaying the target page based on the page resource includes: displaying the target card as a floating layer on the target page.

The floating layer is a page element that floats on the target page.

In this implementation, in order to prevent the display of the target card from being affected by other cards and by the length of the display screen, the display mode of the target card can be preset, in the configuration file of the target page, as the floating layer mode. In this way, when the target page is displayed, the target card is displayed on the target page in a floating manner, and is not affected by the inability to fully display the target page on the display screen because the target card has a smaller size than the target page. Therefore, it is ensured that the card resource of the card that includes only the page logic can be loaded when the page is displayed, and the display of the card is not affected by other cards.

In some embodiments, when the page resource of the target page includes a card resource of the target card, and the card resource of the target card includes only the page logic, a size of the target card is smaller than a preset size threshold. Therefore, fully considering that the target card exists to enable the page logic to be dynamically delivered by the server when the page is displayed, regardless of a view effect of the page display, the size of the target card is set to be smaller than the preset size threshold to minimize the influence of the target card on the view effect of the page.

Optionally, a height of the target card is 0 pixels or 1 pixel. When the height of the target card is 0 pixels or 1 pixel, the page logic included in the target card is loaded during the display of the target page, but the target card has no influence on the view effect of the target page.

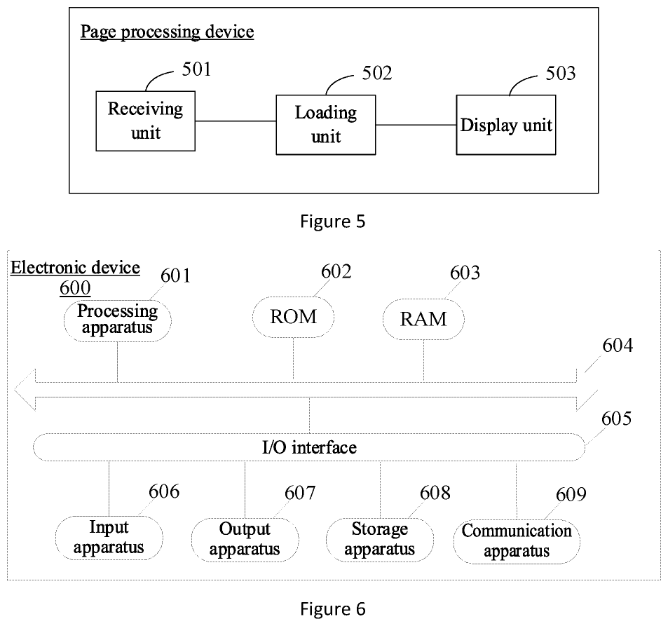

Corresponding to the page processing method in the above embodiment, FIG. 5 is a block diagram of a structure of a page processing device according to an embodiment of the present disclosure. For ease of illustration, only the parts related to the embodiments of the present disclosure are shown. Referring to FIG. 5, the page processing device includes: a receiving unit 501, a loading unit 502, and a display unit 503.

The receiving unit 501 is configured to receive a page display request.

The loading unit 502 is configured to load a page resource of a target page in response to the page display request, where the page resource includes page logic from a server, and the target page is a native page.

The display unit 503 is configured to display the target page based on the page resource.

In some embodiments, the page resource further includes a page framework of the target page. The loading unit 502 is specifically configured to: in response to the page display request, obtain the page framework of the target page locally and send a resource obtaining request to the server; and receive the page logic returned by the server.

In some embodiments, the page resource includes a card resource of a target card, and the card resource of the target card includes only the page logic.

In some embodiments, the page resource further includes a configuration file from the server, and in the configuration file, a display position of the target card is at the top of the target page. The display unit 503 is specifically configured to: display the target card at the top of the target page.

In some embodiments, the target page includes a plurality of cards, the page resource further includes a configuration file from the server, the configuration file includes a display order of the plurality of cards, and the target card is the first card in the plurality of cards in the display order. The display unit 503 is specifically configured to: display the plurality of cards on the target page according to the display order of the plurality of cards.

In some embodiments, the page resource further includes a configuration file from the server, and in the configuration file, a display position of the target card is a fixed position on a display screen. The display unit 503 is specifically configured to: display the target card at the fixed position on the display screen where the target page is located.

In some embodiments, the page resource further includes a configuration file from the server, and in the configuration file, a display mode of the target card is a floating layer mode. The display unit 503 is specifically configured to: display the target card as a floating layer on the target page.

In some embodiments, a size of the target card on the target page is smaller than a preset size threshold.

In some embodiments, a height of the target card is 0 pixels or 1 pixel.

The page processing device provided in this embodiment may be configured to perform the technical solution of the above embodiment related to the page processing method. The implementation principle and technical effects thereof are similar, and are not described herein again in this embodiment.

FIG. 6 is a schematic diagram of a structure of an electronic device 600 suitable for implementing the embodiments of the present disclosure. The electronic device 600 may be a terminal device or a server. The terminal device may include, but is not limited to, a mobile terminal such as a mobile phone, a notebook computer, a digital broadcast receiver, a personal digital assistant (PDA), a tablet computer (Portable Android Device, PAD), a portable media player (PMP), and a vehicle-mounted terminal (such as a vehicle navigation terminal), and a fixed terminal such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processor, a graphics processor) 601 that may perform various appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, a vibrator, etc.; a storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 609 and installed, installed from the storage apparatus 608, or installed from the ROM 602. When the computer program is executed by the processing apparatus 601, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the above method shown in the embodiments.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, an obtaining unit may alternatively be described as “a unit for obtaining a target audio”.

The functions described herein above may be performed at least partially by one or more hardware logic components. For example, without limitation, exemplary types of hardware logic components that may be used include: a field programmable gate array (FPGA), an application-specific integrated circuit (ASIC), application-specific standard parts (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

In a first aspect, according to one or more embodiments of the present disclosure, a page processing method is provided. The method includes: receiving a page display request; loading a page resource of a target page in response to the page display request, where the page resource includes page logic from a server, and the target page is a native page; displaying the target page based on the page resource.

According to one or more embodiments of the present disclosure, the page resource further includes a page framework of the target page; and the loading a page resource of a target page in response to the page display request includes: in response to the page display request, obtaining the page framework of the target page locally and sending a resource obtaining request to the server; and receiving the page logic returned by the server.

According to one or more embodiments of the present disclosure, the page resource includes a card resource of a target card, and the card resource of the target card includes only the page logic.

According to one or more embodiments of the present disclosure, the page resource further includes a configuration file from the server, and in the configuration file, a display position of the target card is at the top of the target page; and the displaying the target page based on the page resource includes: displaying the target card at the top of the target page.

According to one or more embodiments of the present disclosure, the target page includes a plurality of cards, the page resource further includes a configuration file from the server, the configuration file includes a display order of the plurality of cards, and the target card is the first card in the plurality of cards in the display order; and the displaying the target page based on the page resource includes: displaying the plurality of cards on the target page according to the display order of the plurality of cards.

According to one or more embodiments of the present disclosure, the page resource further includes a configuration file from the server, and in the configuration file, a display position of the target card is a fixed position on a display screen; and the displaying the target page based on the page resource includes: displaying the target card at the fixed position on the display screen where the target page is located.

According to one or more embodiments of the present disclosure, the page resource further includes a configuration file from the server, and in the configuration file, a display mode of the target card is a floating layer mode; and the displaying the target page based on the page resource includes: displaying the target card as a floating layer on the target page.

According to one or more embodiments of the present disclosure, a size of the target card on the target page is smaller than a preset size threshold.

According to one or more embodiments of the present disclosure, a height of the target card is 0 pixels or 1 pixel.

In a second aspect, according to one or more embodiments of the present disclosure, a page processing device is provided. The page processing device includes: a receiving unit configured to receive a page display request; a loading unit configured to load a page resource of a target page in response to the page display request, where the page resource includes page logic from a server, and the target page is a native page; and a display unit configured to display the target page based on the page resource.

According to one or more embodiments of the present disclosure, the page resource further includes a page framework of the target page. The loading unit is specifically configured to: in response to the page display request, obtain the page framework of the target page locally and send a resource obtaining request to the server; and receive the page logic returned by the server.

According to one or more embodiments of the present disclosure, the page resource includes a card resource of a target card, and the card resource of the target card includes only the page logic.

According to one or more embodiments of the present disclosure, the page resource further includes a configuration file from the server, and in the configuration file, a display position of the target card is at the top of the target page. The display unit is specifically configured to: display the target card at the top of the target page.

According to one or more embodiments of the present disclosure, the target page includes a plurality of cards, the page resource further includes a configuration file from the server, the configuration file includes a display order of the plurality of cards, and the target card is the first card in the plurality of cards in the display order. The display unit is specifically configured to: display the plurality of cards on the target page according to the display order of the plurality of cards.

According to one or more embodiments of the present disclosure, the page resource further includes a configuration file from the server, and in the configuration file, a display position of the target card is a fixed position on a display screen. The display unit is specifically configured to: display the target card at the fixed position on the display screen where the target page is located.

According to one or more embodiments of the present disclosure, the page resource further includes a configuration file from the server, and in the configuration file, a display mode of the target card is a floating layer mode. The display unit is specifically configured to: display the target card as a floating layer on the target page.

According to one or more embodiments of the present disclosure, a size of the target card on the target page is smaller than a preset size threshold.

According to one or more embodiments of the present disclosure, a height of the target card is 0 pixels or 1 pixel.

In a third aspect, according to one or more embodiments of the present disclosure, an electronic device is provided. The electronic device includes: at least one processor and a memory, where the memory stores computer-executable instructions; and the at least one processor executes the computer-executable instructions stored in the memory, to cause the at least one processor to perform the page processing method as described in the first aspect or various possible designs of the first aspect.

In a fourth aspect, according to one or more embodiments of the present disclosure, a non-transitory computer-readable storage medium is provided, where the computer-readable storage medium stores computer-executable instructions that, when executed by a processor, cause the page processing method as described in the first aspect or various possible designs of the first aspect to be implemented.

In a fifth aspect, according to one or more embodiments of the present disclosure, a computer program product is provided, where the computer program product includes computer-executable instructions that, when executed by a processor, cause the page processing method as described in the first aspect or various possible designs of the first aspect to be implemented.

In a sixth aspect, according to one or more embodiments of the present disclosure, a computer program is provided, where the computer program, when executed by a processor, causes the page processing method as described in the first aspect or various possible designs of the first aspect to be implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A page processing method, comprising:
receiving a page display request;
loading a page resource of a target page in response to the page display request, wherein the page resource comprises page logic from a server, and the target page is a native page; and
displaying the target page based on the page resource.

2. The page processing method according to claim 1, wherein the page resource further comprises a page framework of the target page, and the loading a page resource of a target page in response to the page display request comprises:
in response to the page display request, obtaining the page framework of the target page locally and sending a resource obtaining request to the server; and
receiving the page logic returned by the server.

3. The page processing method according to claim 1,
wherein the page resource comprises a card resource of a target card, and the card resource of the target card comprises only the page logic.

4. The page processing method according to claim 3, wherein the page resource further comprises a configuration file from the server, and in the configuration file, a display position of the target card is at the top of the target page; and
the displaying the target page based on the page resource comprises:
displaying the target card at the top of the target page.

5. The page processing method according to claim 3, wherein the target page comprises a plurality of cards, the page resource further comprises a configuration file from the server, the configuration file comprises a display order of the plurality of cards, and the target card is the first card in the plurality of cards in the display order; and
the displaying the target page based on the page resource comprises:
displaying the plurality of cards on the target page according to the display order of the plurality of cards.

6. The page processing method according to claim 3, wherein the page resource further comprises a configuration file from the server, and in the configuration file, a display position of the target card is a fixed position on a display screen; and
the displaying the target page based on the page resource comprises:
displaying the target card at the fixed position on the display screen where the target page is located.

7. The page processing method according to claim 3, wherein the page resource further comprises a configuration file from the server, and in the configuration file, a display mode of the target card is a floating layer mode; and the displaying the target page based on the page resource comprises:
displaying the target card as a floating layer on the target page.

8. The page processing method according to claim 3, wherein a size of the target card on the target page is smaller than a preset size threshold.

9. The page processing method according to claim 3, wherein a height of the target card is 0 pixels or 1 pixel.

10. (canceled)

11. An electronic device, comprising: at least one processor and a memory,
wherein the memory stores computer-executable instructions; and
the at least one processor executes the computer-executable instructions stored in the memory, to cause the at least one processor to perform the following page processing operations:
receiving a page display request;
loading a page resource of a target page in response to the page display request, wherein the page resource comprises page logic from a server, and the target page is a native page; and
displaying the target page based on the page resource.

12. A non-transitory computer-readable storage medium storing computer-executable instructions that, when executed by a processor, cause the following page processing operations to be implemented;
receiving a page display request;
loading a page resource of a target page in response to the page display request, wherein the page resource comprises page logic from a server, and the target page is a native page; and
displaying the target page based on the page resource.

13. (canceled)

14. (canceled)

15. The electronic device according to claim 11, wherein the page resource further comprises a page framework of the target page, and the loading a page resource of a target page in response to the page display request comprises:
in response to the page display request, obtaining the page framework of the target page locally and sending a resource obtaining request to the server; and
receiving the page logic returned by the server.

16. The electronic device according to claim 11, wherein the page resource comprises a card resource of a target card, and the card resource of the target card comprises only the page logic.

17. The electronic device according to claim 16, wherein the page resource further comprises a configuration file from the server, and in the configuration file, a display position of the target card is at the top of the target page; and
the displaying the target page based on the page resource comprises:
displaying the target card at the top of the target page.

18. The electronic device according to claim 16, wherein the target page comprises a plurality of cards, the page resource further comprises a configuration file from the server, the configuration file comprises a display order of the plurality of cards, and the target card is the first card in the plurality of cards in the display order; and
the displaying the target page based on the page resource comprises:
displaying the plurality of cards on the target page according to the display order of the plurality of cards.

19. The electronic device according to claim 16, wherein the page resource further comprises a configuration file from the server, and in the configuration file, a display position of the target card is a fixed position on a display screen; and
the displaying the target page based on the page resource comprises:
displaying the target card at the fixed position on the display screen where the target page is located.

20. The non-transitory computer-readable storage medium according to claim 12, wherein the page resource further comprises a page framework of the target page, and the loading a page resource of a target page in response to the page display request comprises:
in response to the page display request, obtaining the page framework of the target page locally and sending a resource obtaining request to the server; and
receiving the page logic returned by the server.

21. The non-transitory computer-readable storage medium according to claim 12, wherein the page resource comprises a card resource of a target card, and the card resource of the target card comprises only the page logic.

22. The non-transitory computer-readable storage medium according to claim 21, wherein the page resource further comprises a configuration file from the server, and in the configuration file, a display position of the target card is at the top of the target page; and
the displaying the target page based on the page resource comprises:
displaying the target card at the top of the target page.

23. The non-transitory computer-readable storage medium according to claim 21, wherein the target page comprises a plurality of cards, the page resource further comprises a configuration file from the server, the configuration file comprises a display order of the plurality of cards, and the target card is the first card in the plurality of cards in the display order; and
the displaying the target page based on the page resource comprises:
displaying the plurality of cards on the target page according to the display order of the plurality of cards.
